(19) United States
(12) Patent Application Publication
(10) Pub. No.: US 2024/0151040 A1
(43) Pub. Date: May 9, 2024

(54) PANEL SUPPORT ASSEMBLY

(71) Applicant: HARKK PTY LTD, Wingfield (AU)

(72) Inventors: Thomas William HARTLEY, Wingfield (AU); David John WILLMOTT, Wingfield (AU); Thomas Alistair OVERALL, Wingfield (AU)

(73) Assignee: HARKK PTY LTD, Wingfield, SA (AU)

(21) Appl. No.: 17/769,667

(22) PCT Filed: Oct. 16, 2020
(86) PCT No.: PCT/AU2020/000124

§ 371 Date: Apr. 15, 2022

(30) Foreign Application Priority Data
Oct. 17, 2019 (AU) 2019903914

(51) Int. Cl. E04F 11/18

(52) U.S. Cl. CPC E04F 11/1817; E04F 11/1812; E04F 2011/1831

(57) ABSTRACT

This disclosure relates to a panel support assembly comprising a channel element and a post. In one aspect, the channel element comprises a base, a pair of flanges extending from the base defining a channel therebetween, a neck portion connecting at least one of the pair of flanges to the base, and a first catch portion. The post comprises at least one elongate slot sized and shaped to receive at least a portion of the channel element, and a second catch portion co-operable with the first catch portion to form a catch mechanism to effect securement of the channel element to the post. In use, the channel of the channel element is configured to support an edge of the panel, the portion of the channel element is received and supported by the elongate slot of the post, and is secured to the post by the catch mechanism.

### PRIORITY DOCUMENTS

The present application claims priority from Australian Provisional Patent Application No. 2019903914 titled “PANEL SUPPORT ASSEMBLY” and filed on 17 Oct. 2019, the content of which is hereby incorporated by reference in its entirety.

### INCORPORATION BY REFERENCE

The following co-pending patent application is hereby incorporated by reference in its entirety: International Patent Application No. PCT/AU2020/000124 titled “PANEL SUPPORT ASSEMBLY” in the name of Harkk Pty Ltd.

### TECHNICAL FIELD

The present disclosure relates to a panel support assembly. In particular, the present disclosure relates to a panel support assembly comprising a channel element for receiving and supporting a panel, and a post for receiving and supporting said channel element.

### BACKGROUND

Panel support systems are known for their use in balustrades, pool screens, privacy screens and other screen systems. These existing panel support systems typically include upright posts with channels into which the edge of panels locate. In the case of these panels, silicone sealer and other additional mechanical fasteners/rivets are normally used to secure the edges of the panels within the channels.

There are some drawbacks to such installations. Firstly, it is possible to crack and/or damage the panel when applying mechanical fasteners to secure the edges of the panels within the channels of the upright posts.

Secondly, the posts are required to be accurately located both laterally and angularly such that the channels are correctly aligned, so as to allow the panels to be located in the channels by inserting them from the top of the posts and dropping them into place within the channels. This process of ‘dropping into place’ introduces the potential of cracking and/or damaging the panel during installation, particularly when considering panels manufactured of glass.

Thirdly, the upright posts of existing panel support systems are manufactured typically with two opposing channels, for ease of manufacture. In the instance where only one of the two channels is required for a panel installation, the remaining unused channel is typically covered by an additional blank, or simply left exposed. It is prohibitively costly to produce a range of posts that also offer an ‘end post’ design comprising only a single channel.

Finally, panel support systems are often installed outside and near swimming pools. As such, these panel support systems are exposed to water, the water including salts and or chemicals, which can penetrate and settle into cavities of the post resulting in wear and damage to the post/panel over time. Silicone or other water tight adhesives are often employed in an attempt to address water ingress, however these solutions comprise an additional step that may be overlooked during installation, or may result in visually undesirable sections on the post/panel.

The most common application for panel support systems is the fixing of a plurality of panels between a plurality of upright posts. This produces a structure which can be used for decorative and/or safety purposes, such as a swimming pool enclosure, a wind and noise screen, or as a balustrade, among many examples.

It is against this background and the problems and difficulties associated therewith, that the present invention has been developed.

### SUMMARY

Embodiments of the present disclosure relate to a panel support assembly comprising a channel element and a post, wherein the channel element is configured to receive and support an edge of a panel, the channel element is then subsequently received within a slot of the post and secured therein by a catch mechanism ultimately securing the edge of the panel to the post without the need for mechanical fasteners.

In certain embodiments, the panel support assembly comprises the channel element and the post, wherein the channel element comprises a base, a pair of flanges extending from the base defining a channel therebetween, a neck portion connecting at least one of the pair of flanges to the base, and a first catch portion disposed on one of the pair of flanges; wherein the post comprises at least one slot sized and shaped to receive at least a portion of the channel element therein, a second catch portion disposed within the at least one slot co-operable with the first catch portion to form the catch mechanism to effect securement of the channel element to the post; and wherein the channel of the channel element is configured to support the edge of the panel.

According to a first aspect, there is provided a panel support assembly comprising a channel element and a post; wherein the channel element comprises a base, a pair of flanges extending from the base defining a channel therebetween, a neck portion connecting at least one of the pair of flanges to the base, and a first catch portion, wherein at least one of the pair of flanges comprise the first catch portion; wherein the post comprises at least one elongate slot sized and shaped to receive at least a portion of the channel element, a second catch portion co-operable with the first catch portion to form a catch mechanism to effect securement of the channel element to the post, wherein the at least one elongate slot comprises a pair of walls, and wherein at least one of the pair of walls comprises the second catch portion; and wherein the channel of the channel element is configured to support an edge of a panel.

In one form, the pair of flanges is perpendicular to the base.

In one form, the pair of flanges is angled with respect to the base.

In one form, the channel element comprises a pair of neck portions for the pair of flanges, wherein the pair of neck portions connects the pair of flanges to the base.

In one form, the neck portion allows flexure of its correspondingly connected flange relative to the base.

In one form, the neck portion biases the first catch portion into a capture position with respect to the second catch portion forming the catch mechanism to effect securement of the channel element to the post.

In one form, a user applied force acts against the bias of the neck portion, thereby releasing the first catch portion from the capture position to release the channel element from the post.

In one form, the user applied force is applied to the channel element in a direction perpendicular to the post, thereby releasing the channel element from the at least one elongate slot of the post.

In one form, the user applied force is applied to the channel element in a direction parallel to the post, thereby releasing the channel element from the at least one elongate slot of the post.

In one form, the neck portion comprises a chamfered edge to aid in the securement of the channel element to the post.

In one form, the chamfered edge of the neck portion aids in the releasing of the channel element from the post.

In one form, the neck portion comprises a square edge to aid in the securement of the channel element to the post.

In one form, the channel is a U-shaped channel configured to support the edge of the panel.

In one form, the base is an elongate rectangular base and the pair of flanges extend from either longitudinal side of the elongate rectangular base, thereby defining the U-shaped channel configured to support the edge of the panel.

In one form, the portion of the channel element received in the at least one elongate slot is a length of the pair of flanges.

In one form, the portion of the channel element received in the at least one elongate slot extends between the base and a length of the pair of flanges.

In one form, one of the first or second catch portions comprises one or more ribs, and the other comprises one or more keepers for the one or more ribs.

In one form, a user applied force acts against the one or more ribs, thereby releasing it from its corresponding one or more keepers.

In one form, the pair of flanges comprise an internal face for accommodating the edge of the panel, and an external face.

In one form, at least a portion of the internal face is serrated for aiding in the retention of the edge of the panel.

In one form, a sealant or a glazing material is used on the serrated internal face of the pair of flanges, between the edge of the panel and the internal face, to support the panel securely.

In one form, a passage is defined between the edge of the panel and the base of the channel element.

In one form, a sealant or a glazing material can be located within the passage, between the edge of the panel and the base of the channel element, to hold the panel securely.

In one form, a weather seal can be applied at a top or bottom of the post, to prevent the ingress of water, dust and other elements into the post. In one form, the weather seal is sized and shaped so as to match a profile of the top or the bottom of the post.

In one form, the external face of the pair of flanges comprises the first catch portion.

In one form, the channel element is manufactured of a metal or metal alloy.

In one form, the channel element is cut to a length of the edge of the panel, producing a support stub, and the channel of the cut channel element is sized and shaped for receiving and supporting the edge of the panel.

In one form, both the support stub and the cut channel element are sized and shaped to be received by the at least one elongate slot of the post, whereby, both the support stub and the cut channel element are in alignment on the post.

In one form, the base of either one of the channel element or the support stub depends away from the at least one elongate slot of the post, and a portion of either one of the channel element or the support stub is received by the at least one elongate slot of the post securing either one of the channel element or the support stub to the post by the catch mechanism, whereby both the base of the channel element and the base of the support stub are flush.

In one form, the channel element is a post end received by the at least one elongate slot of the post, whereby the channel element is orientated wherein a length of the pair of flanges is received in the at least one elongate slot and the base depends away therefrom is secured to the post by the catch mechanism.

In one form, whereby, in use, the edge of the panel is supported by the channel of the channel element is received by the at least one elongate slot either in a direction perpendicular to the post, or in a direction parallel to the post, thereby securing the panel received and supported by the channel element to the post of the panel support assembly.

According to a second aspect, there is provided a panel support assembly comprising a channel element and a post; wherein the channel element is comprises a base, a pair of flanges extending from the base to define a channel therebetween, a neck portion connecting at least one of the pair of flanges to the base, and a first catch portion; wherein the post comprises at least one elongate slot sized and shaped to receive at least a portion of the channel element, and a second catch portion co-operable with the first catch portion to form a catch mechanism to effect securement of the channel element to the post; and wherein in use, the channel of the channel element is configured to support an edge of a panel.

According to a further aspect, there is provided a panel support assembly comprising a channel element and a post; wherein the channel element comprises an elongate rectangular base, a pair of flanges extending from either longitudinal side of the elongate rectangular base to define a channel therebetween, a neck portion connecting at least one of the pair of flanges to the elongate rectangular base, the pair of flanges comprising an internal face, wherein at least a portion of the internal face is serrated for aiding in the retention of an edge of a panel, and an external face, wherein the external face of at least one of the pair of flanges comprises a first catch portion; wherein the post comprises at least one elongate slot sized and shaped to receive at least a portion of the channel element, a second catch portion co-operable with the first catch portion to form a catch mechanism to effect securement of the channel element to the post, wherein the at least one elongate slot comprises a pair of walls, and wherein at least one of the pair of walls comprises the second catch portion; and whereby, in use, the edge of the panel is supported by the channel is received by the at least one elongate slot either in a direction perpendicular to the post, or in a direction parallel to the post, thereby securing the panel received and supported by the channel element to the post of the panel support assembly.

### BRIEF DESCRIPTION OF DRAWINGS

Embodiments of the present disclosure will be discussed with reference to the accompanying drawings wherein:

FIG. 1 is an exploded diagram of an embodiment of a panel support assembly.

FIG. 2 is a perspective view of an embodiment of a channel element for the panel support assembly, the channel element used to aid in the fixing of panels between posts of a panel support system;

FIG. 3 is a side view of an embodiment of the channel element of FIG. 2;

FIG. 4 is an aerial view of an embodiment of the channel element of FIG. 2;

FIG. 5 is a perspective view of an alternative embodiment of a channel element for the panel support assembly, the channel element used to aid in the fixing of panels between corner posts of a panel support system;

FIG. 6 is a side view of an embodiment of the channel element of FIG. 5;

FIG. 7 is an aerial view of an embodiment of the channel element of FIG. 5;

FIG. 8 is an aerial view of an embodiment of a weather seal for the panel support assembly of any one of FIGS. 1 to 7;

FIG. 9 shows a first process step illustrating an embodiment of the panel support assembly of FIG. 1 with a support stub and a channel cap being assembled to a post installed in a base plate;

FIG. 10 is shows a second process step illustrating the panel support assembly of FIG. 9 with the channel element of FIG. 2 being assembled to the post;

FIG. 11 is shows a third process step illustrating the panel support assembly of FIGS. 9 and 10 with a second channel cap assembled to a top of the channel element;

FIG. 12 shows a fourth process step illustrating the panel support assembly of FIGS. 9 to 11 with the weather seal of FIG. 8 being assembled to a top of the post;

FIG. 13 shows a fifth process step illustrating the panel support assembly of FIG. 12 with the weather seal installed on the top of the post; and

FIG. 14 is shows sixth process step illustrating the panel support assembly of FIGS. 9 to 13 with a post cap being assembled to the weather seal on top of the post.

In the following description, like reference characters designate like or corresponding parts throughout the figures.

### DESCRIPTION OF EMBODIMENTS

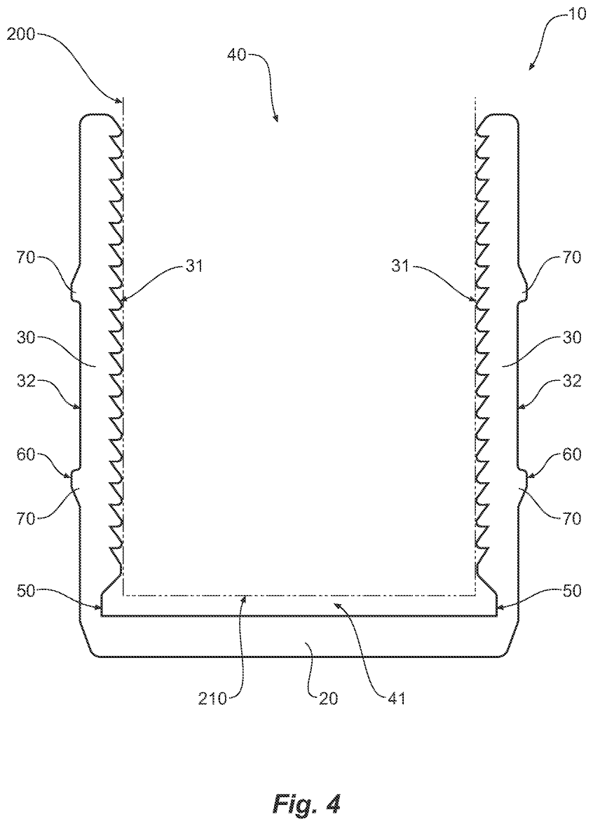

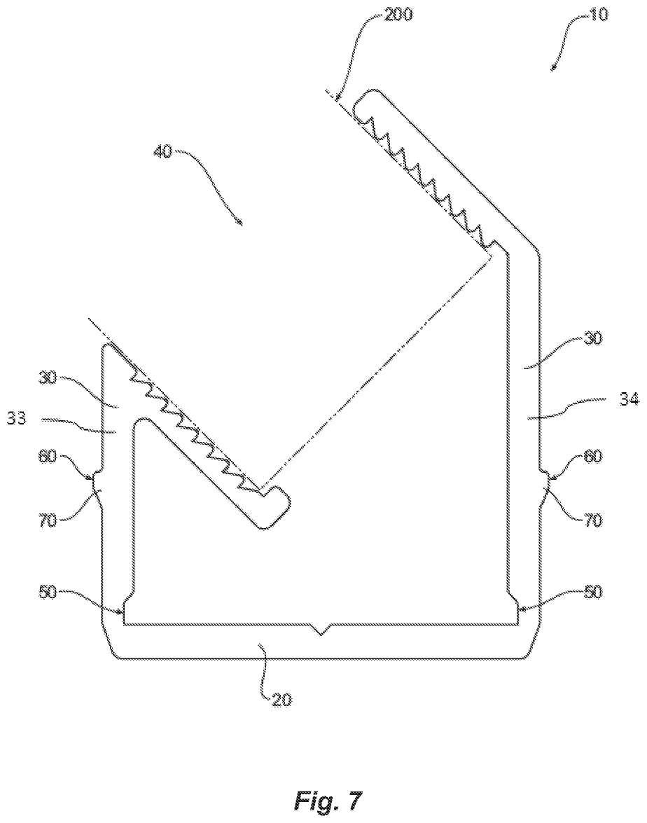

Referring to the Figures, there is illustrated a panel support assembly (100), according to an embodiment, for supporting a panel (200). With reference to FIGS. 4 and 7, the panel support assembly (100) is particularly designed to permit the installation of a panel (200), supported at its edge (210), without the need for mechanical fasteners.

Still referring to the Figures, the panel support assembly (100) comprises a channel element (10) and a post (110). The channel element (10) comprises a base (20), a pair of flanges (30) extending from the base (20) to define a channel (40) therebetween, a neck portion (50) connecting at least one of the pair of flanges (30) to the base (20), and a first catch portion (60). At least one of the pair of flanges (30) may comprise the first catch portion (60). The post (110) comprises at least one elongate slot (111), a second catch portion (120) co-operable with the first catch portion (60) to form a catch mechanism to effect securement of the channel element (10) to the post (110). The elongate slot (111) is sized and shaped to receive at least a portion of the channel element (10) therein. Additionally, the elongate slot (111) may comprise a pair of walls (112). At least one of the pair of walls (112) may comprise the second catch portion (120). Furthermore, the channel (40) of the channel element (10) may be configured to support the edge (210) of the panel (200).

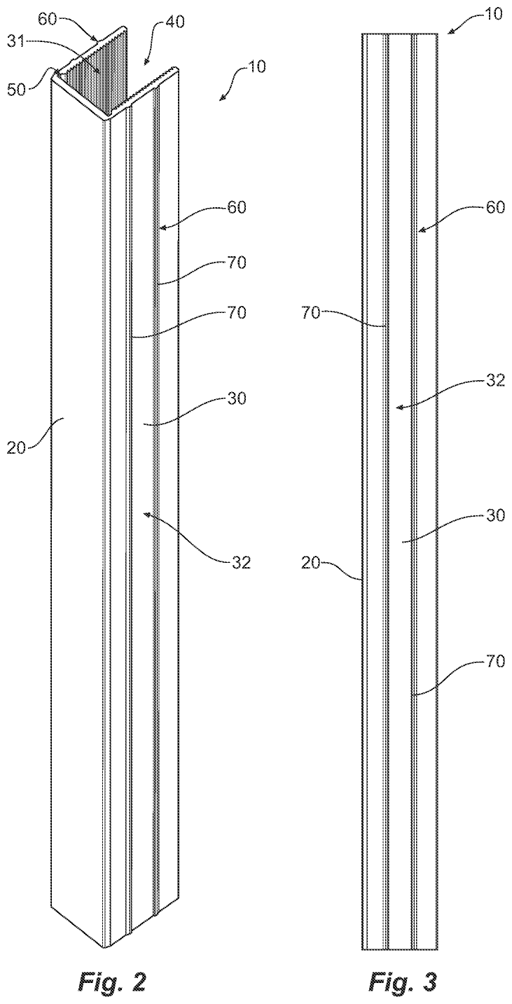

Referring now to FIGS. 2 to 4, in one embodiment, the pair of flanges (30) of the channel element (10) may be perpendicular to the base (20). In this way, the pair of flanges (30) may extend from the base (20) to define a U-shaped channel (40) therebetween for receiving and supporting the edge (210) of the panel (200).

In one embodiment, the pair of flanges (30) may comprise an internal face (31) for accommodating the edge (210) of the panel (200), and an external face (32).

In this particular embodiment, at least a portion of the internal face (31) of the pair of flanges (30) may be serrated for aiding in the retention of the edge (210) of the panel (200). In this way, the internal face (31) of the pair of flanges (30) being serrated, advantageously increases the surface area of the internal face (31). The serrated internal face (31), as can be seen clearly in FIG. 4, advantageously provides an increased surface area for the sealant (such as silicone) and/or a glazing material to bond to. In this way, the serrated internal face (31) of the pair of flanges (30) of the channel element (10), further aids in the retention of the edge (210) of the panel (200).

In this particular embodiment, the sealant or the glazing material may be used on the serrated internal face (31) of the pair of flanges (30), between the edge (210) of the panel (200) and the internal face (31), to support the panel (200) securely.

In one embodiment, the external face (32) of the pair of flanges (30) may comprise the first catch portion (60).

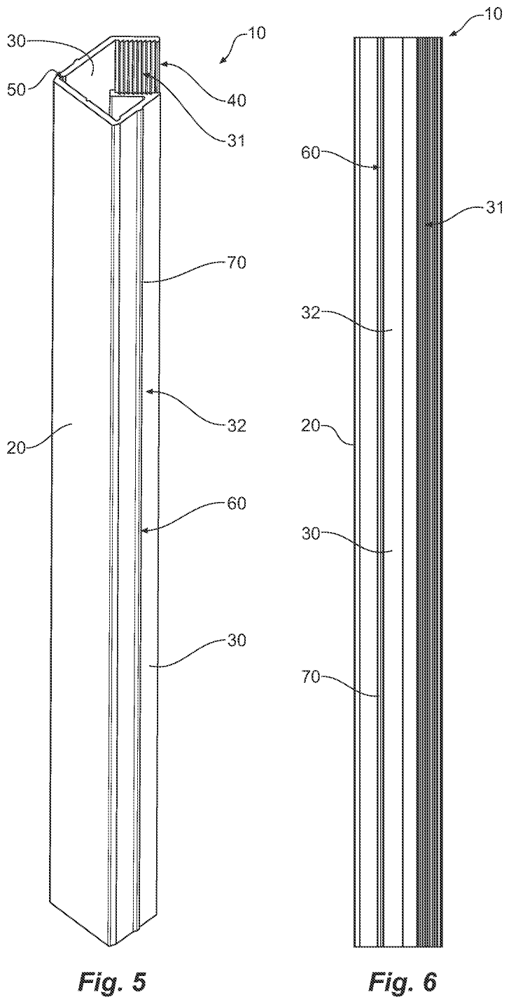

Referring now to any one of FIGS. 5 to 7, the pair of flanges (30) of the channel element (10) may be angled with respect to the base (20). In this way, the pair of flanges (30) may comprise a first flange (33) and a second flange (34) extending from the base (20), whereby, a first portion of each of the first and second flanges (33, 34) may be perpendicular to the base, and a second portion of each of the first and second flanges (33, 34) may be angled with respect to the base (20) to define the channel (40) therebetween for receiving and supporting the edge (210) of the panel (200).

In this particular embodiment, at least a portion of either the first portion of each of the first and second flanges (33, 34) or the second portion of each of the first and second flanges (33, 34) may be serrated for aiding in the retention of the edge (210) of the panel (200). In this way, the channel (40) created by the pair of angled flanges (30), comprise the serration portion for receiving the edge (210) of the panel (200). A remaining portion of either the first portion of each of the first and second flanges (33, 34) or the second portion of each of the first and second flanges (33, 34) may comprise the first catch portion (60).

Additionally, in this particular embodiment, the angled pair of flanges (30) of the channel element (10) advantageously allows the edge (210) of the panel (200) to be received within the channel (40), such that the panel (200) is angled in the direction the pair of flanges (30) is angled to the base (20). Whereby, in use, this particular embodiment of the channel element (10) with the pair of angled flanges (30) may be used in applications where the panel (200) is to be installed at an angle relative to the post (110) of the panel support assembly (100).

Referring now to any one of the Figures, in one embodiment, the channel element (10) may comprise a pair of neck portions (50) for the pair of flanges (30). The pair of neck portions (50) connecting the pair of flanges (30) to the base (20). The neck portion (50) allowing flexure of its correspondingly connected flange (30) relative to the base. In the instance that the correspondingly connected flange (30) comprises the first catch portion (60), the neck portion (50) biases the first catch portion (60) into a capture position with respect to the second catch portion (120) forming the catch mechanism to effect securement of the channel element (10) to the post (110).

In this particular embodiment, the flexure provided by the neck portion (50) to its correspondingly connected flange (30) may be overcome by a user applied force that acts against the bias of the neck portion (50), thereby releasing the first catch portion (60) from the capture position to release the channel element (10) from the post (110).

In one embodiment, the neck portion (50) connecting the corresponding flange (30) to the base (20) may be a chamfered edge to aid in the securement of the channel element (10) to the post (110). Additionally, in this way, the chamfered edge of the neck portion (50) may also aid in the releasing of the channel element (10) from the post (110).

In an alternative embodiment, the neck portion (50) connecting the corresponding flange (30) to the base (20) may be a square edge to aid in the securement of the channel element (10) to the post (110). It will be appreciated that the neck portion (50) may take further alternate forms to connect the corresponding flange (30) to the base (20) to aid in both the securement and release of the channel element (10) from the post (110).

Referring once more to any one of the Figures, in one embodiment, one of the first (60) or second (120) catch portions may comprise one or more ribs (70), and the other may comprise one or more keepers (80) for the one or more ribs (70). In this way, the one or more ribs (70) is co-operable with the one or more keepers (80) to form the catch mechanism to effect securement of the channel element (10) to the post (110).

In this embodiment, a user applied force acts against the one or more ribs (70), thereby releasing it from its corresponding one or more keepers (80).

In an alternative embodiment, one of the first (60) or second (120) catch portions may be a cantilever snap (not shown) and the other is a keeper (not shown) for the cantilever snap. In this way, the cantilever snap is co-operable with the keeper to form the catch mechanism to effect securement of the channel element (10) to the post (110). It will be appreciated, that further embodiments for the first (60) or second (120) catch portions are envisaged beyond those disclosed to co-operate to form the catch mechanism to effect securement of the channel element (10) to the post (110).

In one embodiment, the user applied force may be applied to the channel element (10) in a direction perpendicular to the post (110), thereby releasing the first catch portion (60) or the one or more ribs (70) from the capture position (i.e. with respect to the co-operable second catch portion (120) or the one or more keepers (80), thus releasing the channel element (10) from the at least one elongate slot (111) of the post (110).

In one embodiment, the user applied force may be applied to the channel element (10) in a direction parallel to the post (110), thereby releasing the channel element (10) from the at least one elongate slot (111) of the post (110).

In one embodiment, the base (20) may be an elongate rectangular base (20), and the pair of flanges (30) extend from either longitudinal side of the base (20), thereby defining the channel (40) therebetween for receiving and supporting the edge (210) of the panel (200).

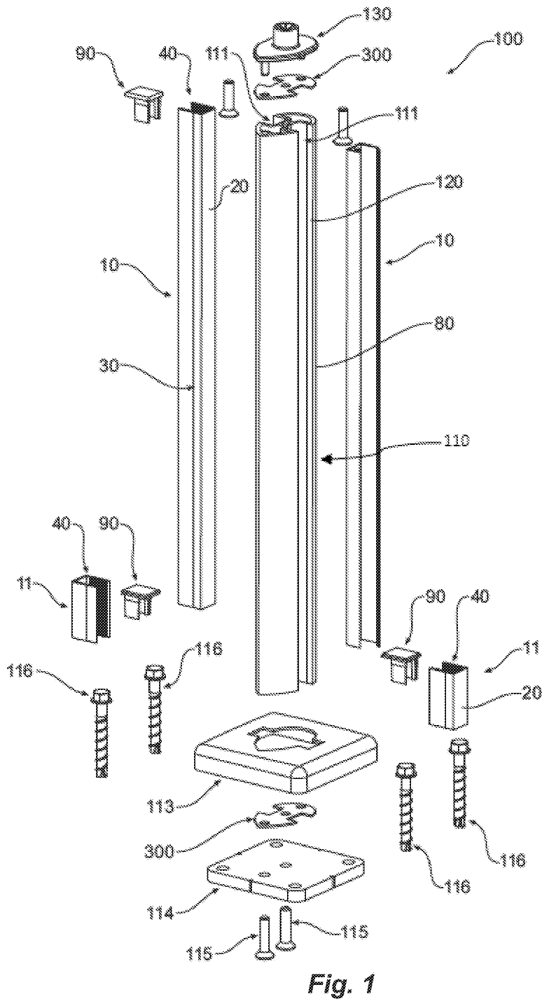

Referring now to FIG. 1, in one embodiment, the portion of the channel element (10) received by the at least one elongate slot (111) of the post (110), may be a length of the pair of flanges (30) of the channel element (10). In this way, the base (20) of the channel element (10) is received in the at least one elongate slot (111) and the length of the pair of flanges (30) bear against the pair of walls (112) of the at least one elongate slot (111). In this particular embodiment, the channel (40) defined by the pair of flanges (30) of the channel element (10) is configured to support the edge (210) of the panel (200).

Referring now to either one of FIG. 4 or 7, in one embodiment, whereby in use, a passage (41) may be defined between the edge (210) of the panel (200) and the base (20) of the channel element (10). In this particular embodiment, the sealant or the glazing material (or a further sealant or glazing material) may be located within the passage (41) between the edge (210) of the panel (200) and the base (20) of the channel element (10), to hold the panel (200) securely within the channel (40) of the channel element (10). It will be appreciated that the passage (41) provides some clearance that may provide a slight interference fit between the edge (210) of the panel (200) and the base (20) of the channel element (10), which advantageously permits small adjustments to be made when installing the panel (200) to be supported by the panel support assembly (100).

Referring once more to FIG. 1, in an alternative embodiment, the portion of the channel element (10) received by the at least one elongate slot (111) of the post (110), may be a length of the pair of flanges (30) of the channel element (10). In this way, the base (20) of the channel element (10) depends away from the at least one elongate slot (111), and only the length of the pair of flanges (30) bear against the pair of walls (112) of the pair of walls (112) of the at least one elongate slot (111). In this particular embodiment, the channel (40) defined by the pair of flanges (30) of the channel element (10) is concealed within the at least one elongate slot (111) of the post, thereby, the channel (40) of the channel element (10) acts as a post end received in the at least one elongate slot (111) of the post (110).

In this particular embodiment, it will be appreciated that the channel element (10) advantageously has a dual purpose, the first being to support and receive the edge (210) of the panel (200) in its channel (40), and the second being the post end where the channel (40) is received in the at least one elongate slot (111) of the post (110). In this way, the channel element (10) is advantageously reversible, and is sized and shaped to be received by the at least one elongate slot (111) of the post (110) in either orientation.

Referring again to FIG. 1, in one embodiment, the channel element (10) may be cut to a length of the edge (210) of the panel (200). In this way, the channel (40) of the cut channel element (10) is sized and shaped for receiving and supporting the edge (210) of the panel (200), and the remaining length of the channel element (10) produces a support stub (11).

In this particular embodiment, both the support stub (11) and the cut channel element (10) are sized and shaped to be received by the at least one elongate slot (111) of the post (110), whereby, both the support stub (11) and the cut channel element (10) may be in alignment on the post (110). In this way, the base (20) of either one of the cut channel element (10) or the support stub (11) may depend away from the at least one elongate slot (111) of the post (110), and a portion of either one of the cut channel element (10) or the support stub (11) is received by the at least one elongate slot (111) of the post (110) securing either one of the cut channel element (10) or the support stub (11) to the post (110) by the catch mechanism, whereby both the base (20) of the channel element (10) and the base (20) of the support stub (11) are flush. It will be appreciated by a person skilled in the art, that the support stub (11) may be known as a glazing support.

In this particular embodiment, in an alternative, the base (20) of the support stub (11) may depend away from the at least one elongate slot (111) of the post (110), and a portion of the support stub (11) is received by the at least one elongate slot (111) of the post (110). In this way, the support stub (11) may be a blank support stub or an end piece, and may support the edge (210) of the panel (200) received within the channel (40) of the cut channel element (10) by bearing against the support stub (11).

Referring to any one of the Figures, in one embodiment, the channel element (10) may be manufactured of a metal or a metal alloy, thereby allowing the neck portion (50) to provide flexure of its correspondingly connected flange (30) relative to the base and biasing the first catch portion (60) into a capture position with respect to the second catch portion (120) forming the catch mechanism to effect securement of the channel element (10) to the post (110). It will be appreciated that the manufacture of the channel element (10) from a metal or a metal alloy advantageously aids in cutting the channel element (10) to the length of the edge (210) of the panel (200), while retaining the channel element (10) original structure and rigidity.

Referring to FIG. 1, and in any one of the above embodiments, the channel element (10) may further comprise a channel cap (90). The channel cap (90) being designed to provide a means to cover a top or bottom of the channel element (10) when installed thereon, so as to further contain the edge (210) of the panel (200) received within the channel (40) of the channel element (10).

In one embodiment, the post (110) of the panel support assembly (100) may comprise a first and a second elongate slot (111), positioned about the post (110). Whereby, both first and second elongate slots (111) are sized and shaped to receive at least the portion of the channel element (10) therein. Additionally, each of the first and second elongate slots (111) may comprise the pair of walls (112), where at least one of the pair of walls (112) of each of the first and second elongate slots (111) may comprise the second catch portion (120) co-operable with the first catch portion (60) of the channel element (10), thereby forming the catch mechanism to effect securement of the channel element (10) to the panel support assembly (100).

In this particular embodiment, the post (110) of the panel support assembly (100) comprising the first and second elongate slots (111), may correspondingly receive a corresponding first and second channel elements (10) and/or first and second support stubs (11) therein. In this way, the panel support assembly (100) may support a first edge of a panel (not shown) by the channel (40) of the first channel element (10) received in the corresponding first elongate slot (111), and a second edge of a panel (not shown) by the channel (40) of the second channel element (10) received in the corresponding second elongate slot (111).

It will be appreciated that the post (110) may comprise more elongate slots (111) dependent on the post (110) design, size and application. Accordingly, further corresponding channel elements (10) and/or support stubs (11) may be received therein.

Referring now to FIG. 1, in any one of the above embodiments, the panel support assembly (100) may further comprise a post cap (130). The post cap (130) being designed to provide a means to cover a top of the post (110), and bear against the one or more channel caps (90) when installed thereon. In this way, the combination of the post cap (130), the one or more channel caps (90), and the channel element (10) advantageously provide an IP5 water ingress rating to the panel support assembly (100).

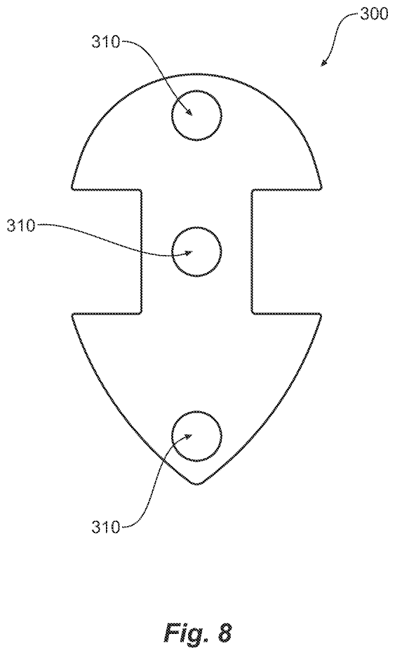

In this embodiment, referring to any one of FIG. 1 or 8, a weather seal (300) may be applied between the post cap (130) and a top of the post (110), or between a bottom of the post (110) and a base plate (114) of the panel support assembly (100) (as illustrated in FIG. 1). With particular reference to FIG. 8, the weather seal (300) may be sized and shaped so as to match a profile of the post cap (130) and either the top or the bottom of the post (110). Accordingly, the weather seal (300) may comprise one or more apertures (310), such that the one or more apertures (310) concord in location with securement means that the post cap (130) may comprise for securing onto either the top or the bottom of the post (110). The weather seal (300) may be any one of a silicone sealant, a rubber gasket, other elastomeric sealants or well known weather stripping means to prevent the ingress of water, dust and other elements. In this embodiment, the weather seal (300) further shores up the IP5 water ingress rating to the panel support assembly (100). It will be apparent that, in use, the weather seal (300) removes the requirement to use other sealant type products (such as silicone or other adhesives) which often results in a visually undesirable aesthetic on the post (110).

Referring to any one of the above embodiments, it will be appreciated that a pair of panel support assemblies (100) would provide the means to support the panel (200) by either of its opposing edges (210), by virtue of the pair of panel support assemblies (100) being spaced apart to accommodate the length of the panel (200) between its opposing edges (210).

It will be appreciated that in any one of the embodiments described above, that the catch mechanism formed by the co-operable first (60) and second (120) catch portions, advantageously allows for a quick and easy installation means for supporting the edge (210) of the panel (200) with the use of the channel element (10) and the post (110) of the panel support assembly (100) without the need for any mechanical fasteners. Furthermore, the flexure provided by the neck portion (50) to its correspondingly connected flange (30) of the channel element (10), may advantageously be overcome by the user applied force that acts against the bias of the neck portion (50), thereby permitting the quick and easy releasing means for the channel element (10) from the post (110), and the edge (210) of the panel (200) supported by the channel (40) of the channel element (10).

It will also be appreciated that in any one of the embodiments described above, that in use, the edge (210) of the panel (200) supported by the channel (40) of the channel element (10) may be received by the at least one elongate slot (111) either in a direction perpendicular to the post (110), or in a direction parallel to the post (110), thereby securing the panel (200) received and supported by the channel element (10) to the post (110) of the panel support assembly (100). In this way, advantageously, the panel support assembly (100) reduces the potential of cracking and/or damaging the panel (200) during installation, particularly when considering panels made of glass, as the panel support assembly (100) allows the installation of the channel element (10) supporting the panel (200) in a direction perpendicular to the post (110).

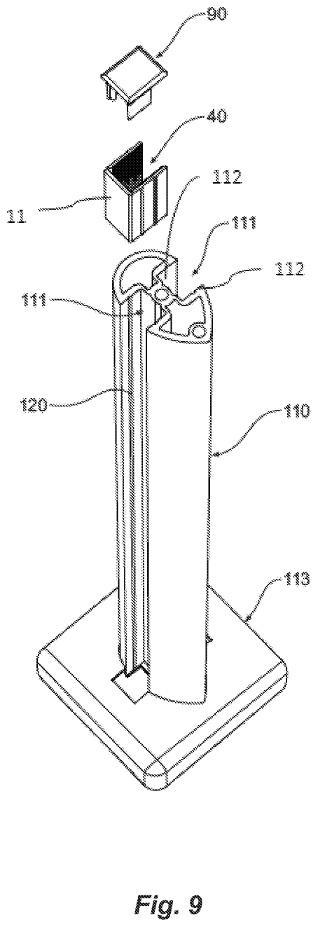

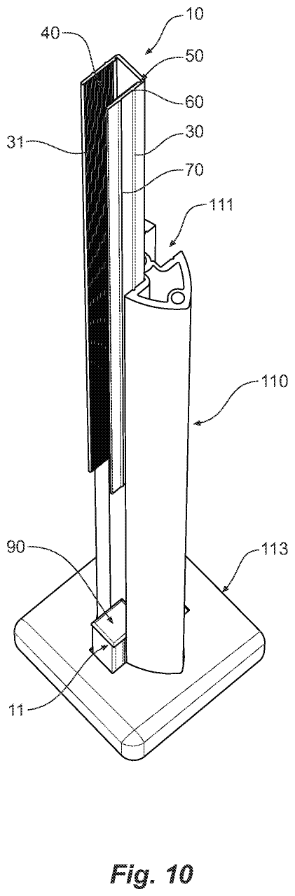

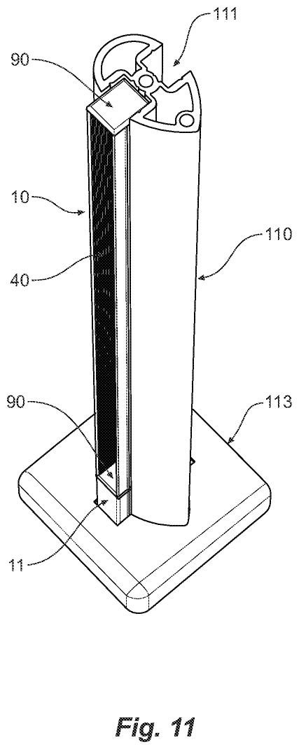

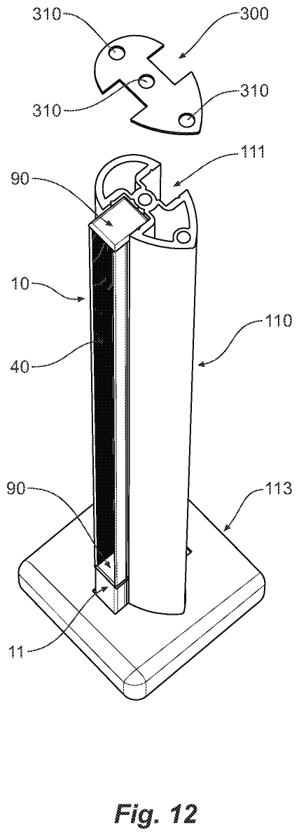

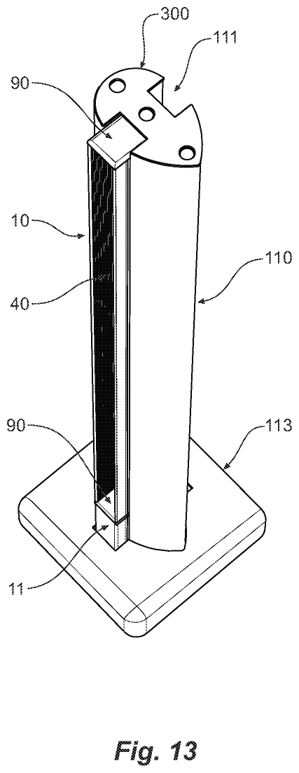

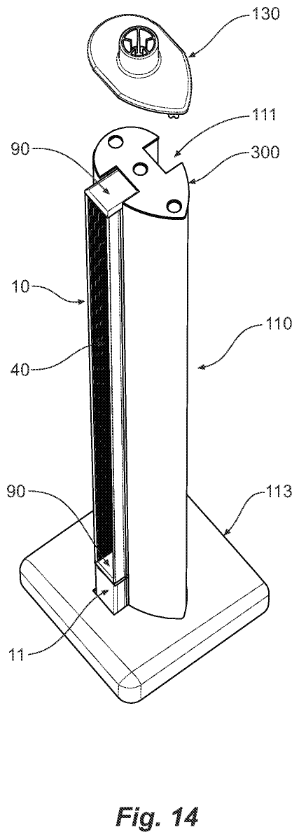

With particular reference to FIGS. 9 to 14, an exemplary process is illustrated showing the steps by which the panel support assembly 100 and its composition may be assembled. By way of example only, this process may involve the steps of:
1. Referring first to FIG. 9, the post (110) being assembled (or installed and secured) to a base plate (114) covered by a base cover (113), followed by inserting the support stub (11) in either a direction perpendicular to or parallel to the post (110) via the elongate slot (111) of the post (110) in a reverse orientation and secured by the catch mechanism, and a first of the channel cap (90) assembled onto the support stub (11);
2. Referring now to FIG. 10, the channel element (10) is assembled to the post (110) by inserting the channel element (10) into the elongate slot (111) in either a direction perpendicular or parallel to the post (110);
3. Referring now to FIG. 11, a second of the channel cap (90) is assembled to the top of the channel element (10);
4. Referring now to FIGS. 12 and 13, the weather seal (300) is applied to the top of the post (110) such that its profile and apertures concord with that of the top of the post (110); and
5. Finally referring to FIG. 14, the post cap (130) is assembled and secured to the top of the post (110), compressing and securing the weather seal (300) to the top of the post (110) so as to shore up the IP5 water ingress rating to the panel support assembly (100) and doing so without the requirement of other sealant type products.

An exemplary method for supporting the panel (200) by use of the panel support assembly (100) of any one of the embodiments, may comprise the steps of:
a. Marking out the positions of the posts (110) of the two or more panel support assemblies (100) are required, each pair of panel support assemblies (100) spaced apart to accommodate the length of the panel (200) between its opposing edges (210);
b. Fixing the two or more panel support assemblies (100) at their respective posts (110) to a base cover (113) by a base plate (114) and one or more securing screws (115);
c. Fixing the two or more panel support assemblies (100) coupled with their base covers (113) to a surface (not shown) by one or more surface fixing screws (116);
d. Cutting the channel element (10) to a length of the edge (210) of the panel (200), producing the support stub (11), and the channel (40) of the cut channel element (10) sized and shaped for receiving and supporting the edge (210) of the panel (200);
e. Inserting the cut channel element (10) and the support stub (11) in the at least one elongate slot (111) of the post (110), the installation of the cut channel element (10) and the support stub (11) carried out in either in a direction perpendicular to the post (110), or in a direction parallel to the post (110), thereby securing the cut channel element (10) and support stub (11) to the post (110) of the corresponding panel support assembly (100), in this way, the first (60) and second (120) catch portions form the catch mechanism to effect securement of the cut channel element (10) and the support stub (11) to the post (110);
f. Repeating the above step for the number of channel elements (10) and support stubs (11) required for the corresponding number of posts (110);
g. Installing a number of channel caps (90) corresponding to the number of cut channel elements (10) and/or support stubs (11) required;
h. Attaching a number of the post caps (130) to each panel support assembly (100);
i. Apply any glazing material (as required) to the channel (40) of each channel element (10) and insert the panel (200) via its edges (210) between the pair of panel support assemblies (100), where the edges (210) of the panel (200) are received in each corresponding channel (40) of the channel elements (10);
j. The sealant (such as silicone) is then applied at each of the edges (210), between the edge (210) of the panel (200) and internal face (31) of the channel element (10) to support the panel (200) securely;
k. And finally, it will be apparent to those skilled in the art that any other items required for the panel support assembly (100), such as handrails, additional caps, gaskets are applied to finish the installation.

It will be appreciated by those skilled in the art, that at step “d” of the method above, that there are a number of methods by which the channel element (10) (manufactured of the metal or metal alloy) may be cut.

Additionally, it will be apparent to those skilled in the art that alternate methods of use of the panel support assembly (100) of any one of the embodiments disclosed are anticipated.

Referring to any one of the above embodiments, it will be appreciated that any number of panel support assemblies (100) may be used to support a number of panels (200) to find numerous applications ranging from glass screen or walls, balustrades, or any other application where panels need to be held between support posts. It will also be appreciated that any one of the embodiments may be used on horizontal surfaces, and equally suited to inclines such as the sides of stairs or on sloping ground.

In addition to the use of flat panels such as panes of glass, it should be understood that the word panel is used in this specification to also include panels of complex shape including curved panels, segmented panels or panels having a combination of curved and flat surfaces

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A panel support assembly comprising a channel element and a post;
wherein the channel element comprises a base, a pair of flanges extending from the base defining a channel therebetween, a neck portion connecting at least one of the pair of flanges to the base, and a first catch portion, wherein at least one of the pair of flanges comprise the first catch portion;
wherein the post comprises at least one elongate slot sized and shaped to receive at least a portion of the channel element, a second catch portion co-operable with the first catch portion to form a catch mechanism to effect securement of the channel element to the post, wherein the at least one elongate slot comprises a pair of walls, and wherein at least one of the pair of walls comprises the second catch portion; and
wherein the channel of the channel element is configured to support an edge of a panel.

2. The panel support assembly of claim 1, wherein the pair of flanges is perpendicular to the base.

3. The panel support assembly of claim 1, wherein the pair of flanges is angled with respect to the base.

4. The panel support assembly of claim 1, wherein the channel element comprises a pair of neck portions for the pair of flanges, wherein the pair of neck portions connects the pair of flanges to the base.

5. The panel support assembly of claim 1, wherein the neck portion allows flexure of its correspondingly connected flange relative to the base.

6. The panel support assembly of claim 1, wherein the neck portion biases the first catch portion into a capture position with respect to the second catch portion forming the catch mechanism to effect securement of the channel element to the post.

7. The panel support assembly of claim 6, wherein a user applied force acts against a bias of the neck portion, thereby releasing the first catch portion from the capture position to release the channel element from the post.

8. The panel support assembly of claim 1, wherein one of the first or second catch portions comprises one or more ribs, and the other comprises one or more keepers for the one or more ribs.

9. The panel support assembly of claim 8, wherein a user applied force acts against the one or more ribs, thereby releasing it from its corresponding one or more keepers.

10. The panel support assembly of claim 1, wherein the pair of flanges comprise an internal face for accommodating the edge of the panel, and an external face.

11. The panel support assembly of claim 10, wherein at least a portion of the internal face is serrated for aiding in retention of the edge of the panel.

12. The panel support assembly of claim 11, wherein a sealant or a glazing material is used on the serrated internal face of the pair of flanges, between the edge of the panel and the internal face, to support the panel securely.

13. The panel support assembly of claim 10, wherein the external face of the pair of flanges comprises the first catch portion.

14. The panel support assembly of claim 1, wherein the channel element is cut to a length of the edge of the panel, producing a support stub, and the channel of the cut channel element is sized and shaped for receiving and supporting the edge of the panel.

15. The panel support assembly of claim 14, wherein both the support stub and the cut channel element are sized and shaped to be received by the at least one elongate slot of the post, whereby, both the support stub and the cut channel element are in alignment on the post.

16. The panel support assembly of claim 15, wherein the base of either one of the channel element or the support stub depends away from the at least one elongate slot of the post, and a portion of either one of the channel element or the support stub is received by the at least one elongate slot of the post securing either one of the channel element or the support stub to the post by the catch mechanism, whereby both the base of the channel element and the base of the support stub are flush.

17. The panel support assembly of claim 1, whereby, in use, the edge of the panel is supported by the channel of the channel element is received by the at least one elongate slot either in a direction perpendicular to the post, or in a direction parallel to the post, thereby securing the panel received and supported by the channel element to the post of the panel support assembly.

18. A panel support assembly comprising a channel element and a post; wherein the channel element is-comprises a base, a pair of flanges extending from the base to define a channel therebetween, a neck portion connecting at least one of the pair of flanges to the base, and a first catch portion; wherein the post comprises at least one elongate slot sized and shaped to receive at least a portion of the channel element, and a second catch portion co-operable with the first catch portion to form a catch mechanism to effect securement of the channel element to the post; and wherein in use, the channel of the channel element is configured to support an edge of a panel.

19. A panel support assembly comprising a channel element and a post; wherein the channel element comprises an elongate rectangular base having longitudinal sides, a pair of flanges extending from either longitudinal side of the elongate rectangular base to define a channel therebetween, a neck portion connecting at least one of the pair of flanges to the elongate rectangular base, the pair of flanges comprising an internal face, wherein at least a portion of the internal face is serrated for aiding in retention of an edge of a panel, and an external face, wherein the external face of at least one of the pair of flanges comprises a first catch portion; wherein the post comprises at least one elongate slot sized and shaped to receive at least a portion of the channel element, a second catch portion co-operable with the first catch portion to form a catch mechanism to effect securement of the channel element to the post, wherein the at least one elongate slot comprises a pair of walls, and wherein at least one of the pair of walls comprises the second catch portion; and whereby, in use, the edge of the panel is supported by the channel is received by the at least one elongate slot either in a direction perpendicular to the post, or in a direction parallel to the post, thereby securing the panel received and supported by the channel element to the post of the panel support assembly.
